(19) United States
(12) Patent Application Publication
(10) Pub. No.: US 2024/0056982 A1
(43) Pub. Date: Feb. 15, 2024

(54) TRANSMIT POWER CONTROL FOR UPLINK SIGNALS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/359,712

(22) Filed: Jul. 26, 2023

Related U.S. Application Data
(60) Provisional application No. 63/396,504, filed on Aug. 9, 2022.

(51) Int. Cl. H04W 52/14; H04W 52/24

(52) U.S. Cl. CPC H04W 52/146; H04W 52/242

(57) ABSTRACT

Methods and apparatuses for transmit power control (TPC) for uplink (UL) signals. A method includes receiving first information for a set of operation states for a set of cells and second information for a set of values for a power control parameter. The method further includes determining a first power for a transmission of a first physical uplink control channel (PUCCH) based on the first PUCCH including first information bits that indicate a first operation state from the set of operation states for a first cell from the set of cells and a first value from the set of values for the power control parameter. The method further includes transmitting the first PUCCH with the first power.

### CROSS-REFERENCE TO RELATED AND CLAIM OF PRIORITY

The present application claims priority under 35 U.S.C. § 119(e) to U.S. Provisional Patent Application No. 63/396,504 filed on Aug. 9, 2022, which is hereby incorporated by reference in its entirety.

### TECHNICAL FIELD

The present disclosure relates generally to wireless communication systems and, more specifically, the present disclosure relates to methods and apparatuses for transmit power control (TPC) for uplink (UL) signals.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance. To meet the demand for wireless data traffic having increased since deployment of 4G communication systems, and to enable various vertical applications, 5G communication systems have been developed and are currently being deployed.

### SUMMARY

The present disclosure relates to TPC for UL signals.

In one embodiment, a user equipment (UE) is provided. The UE includes a transceiver configured to receive first information for a set of operation states for a set of cells and second information for a set of values for a power control parameter. The UE further includes a processor operably coupled to the transceiver. The processor is configured to determine a first power for a transmission of a first physical uplink control channel (PUCCH) based on the first PUCCH including first information bits that indicate a first operation state from the set of operation states for a first cell from the set of cells and a first value from the set of values for the power control parameter. The transceiver is further configured to transmit the first PUCCH with the first power.

In another embodiment, a base station (BS) is provided. The BS includes a transceiver configured to transmit first information for a set of operation states for a set of cells and second information for a set of values for a power control parameter. The BS further includes a processor operably coupled to the transceiver. The processor is configured to determine a first power for a reception of a first PUCCH based on the first PUCCH including first information bits that indicate a first operation state from the set of operation states for a first cell from the set of cells and a first value from the set of values for the power control parameter. The transceiver is further configured to receive the first PUCCH with the first power.

In yet another embodiment, a method is provided. The method includes receiving first information for a set of operation states for a set of cells and second information for a set of values for a power control parameter. The method further includes determining a first power for a transmission of a first PUCCH based on the first PUCCH including first information bits that indicate a first operation state from the set of operation states for a first cell from the set of cells and a first value from the set of values for the power control parameter. The method further includes transmitting the first PUCCH with the first power.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIGS. 5A and 5B illustrate an example of a transmitter and receiver structures using orthogonal frequency-division multiplexing (OFDM) according to embodiments of the present disclosure;

FIG. 6 illustrates an example of a flowchart of a UE determining a power for a PUCCH transmission with simultaneous transmission and receive (STR) information based on a set of parameters indicated for PUCCH according to embodiments of the present disclosure;

FIG. 7 illustrates an example of a flowchart of a UE determining a nominal power for a PUCCH transmission according to embodiments of the present disclosure;

FIG. 8 illustrates an example of a flowchart of UE determining a power for a PUCCH transmission with STR information based on a pathloss calculated from a synchronization signal/physical broadcast channel (SS/PBCH) block index according to embodiments of the present disclosure;

FIG. 9 illustrates an example of a flowchart of a UE determining a power for a PUCCH transmission depending on whether the PUCCH provides uplink control information (UCI) or STR information according to embodiments of the present disclosure;

FIG. 10 illustrates an example of a flowchart of a UE determining a power for a PUCCH transmission with STR information based on pathloss measurements from SS/PBCH blocks or channel state information reference signal (CSI-RS) resources according to embodiments of the present disclosure;

FIG. 11 illustrates an example of a flowchart of a UE selecting a cell for PUCCH transmission with STR information according to embodiments of the present disclosure;

FIG. 12 illustrates an example of a flowchart of a UE determining a pathloss measurement for a PUCCH transmission triggered by a (PDCCH) reception according to embodiments of the present disclosure;

FIG. 13 illustrates an example of a flowchart of a UE transmitting a channel/signal with a power calculated according to embodiments of the present disclosure; and

FIG. 14 illustrates an example of a flowchart of a UE determining a transmission power of a channel/signal using a common close-loop power control (CLPC) adjustment state according to embodiments of the present disclosure.

### DETAILED DESCRIPTION

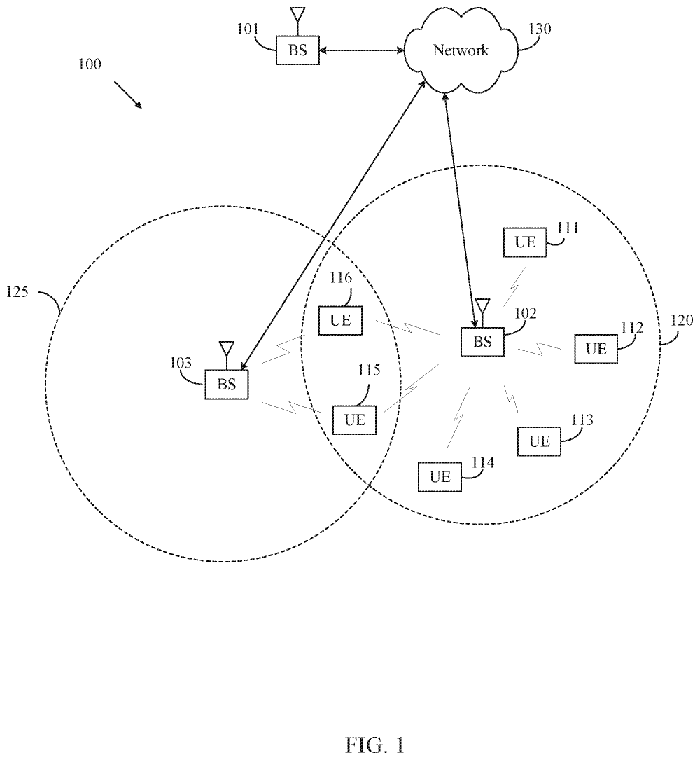

FIGS. 1-14, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to the deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.2.0, “NR; Physical channels and modulation”; [2] 3GPP TS 38.212 v17.2.0, “NR; Multiplexing and channel coding”; [3] 3GPP TS 38.213 v17.2.0, “NR; Physical layer procedures for control”; [4] 3GPP TS 38.214 v17.2.0, “NR; Physical layer procedures for data”; [5] 3GPP TS 38.321 v17.1.0, “NR; Medium Access Control (MAC) Protocol Specification”; [6] 3GPP TS 38.331 v17.1.0, “NR; Radio Resource Control (RRC) Protocol Specification”.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing TPC for UL signals. In certain embodiments, one or more of the BSs 101-103 include circuitry, programing, or a combination thereof to support TPC for UL signals.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

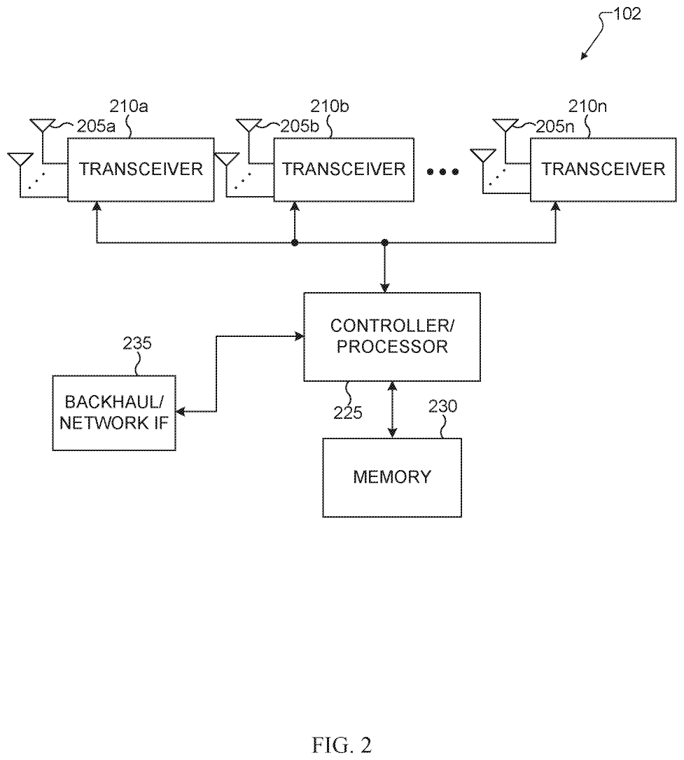

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting TPC for UL signals. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

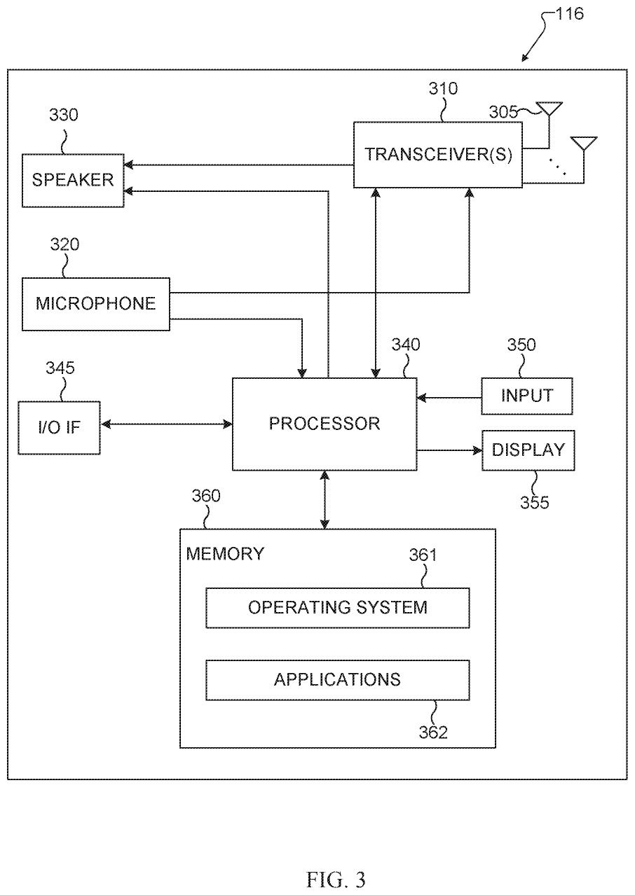

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying and utilizing TPC for UL signals as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

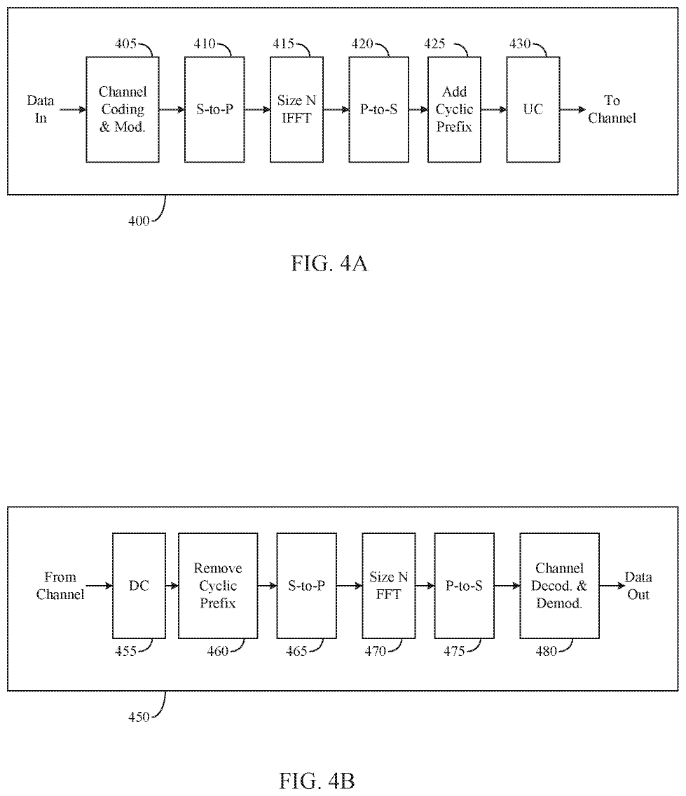

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to receive information to support TPC for UL signals as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

The text and figures are provided solely as examples to aid the reader in understanding the embodiments of the present disclosure. They are not intended and are not to be construed as limiting the scope of the embodiments of the present disclosure in any manner. Although certain embodiments and examples have been provided, it will be apparent to those skilled in the art, based on the disclosures herein, that changes in the embodiments and examples shown may be made without departing from the scope of the embodiments of the present disclosure.

The flowcharts described herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In the following, an italicized name for a parameter implies that the parameter is provided by higher layers.

DL transmissions or UL transmissions can be based on an OFDM waveform including a variant using DFT precoding that is known as DFT-spread-OFDM that is typically applicable to UL transmissions.

A unit for DL signaling or UL signaling on a cell is referred to as a slot and can include one or more symbols. A bandwidth (BW) unit is referred to as a resource block (RB). One RB includes a number of sub-carriers (SCs). For example, a slot can have a duration of one millisecond and a RB can have a bandwidth of 180 kHz and include 12 SCs with inter-SC spacing of 15 kHz. A sub-carrier spacing (SCS) can be determined by a SCS configuration λ as 2^{μ}·kHz. A unit of one sub-carrier over one symbol is referred to as a resource element (RE). A unit of one RB over one symbol is referred to as physical RB (PRB).

DL signals include data signals conveying information content, control signals conveying DL control information (DCI), reference signals (RS), and synchronization signals. A gNB transmits data information or DCI through respective physical DL shared channels (PDSCHs) or physical DL control channels (PDCCHs). A PDSCH or a PDCCH transmission can be over a variable number of slot symbols including one slot symbol. A gNB transmits one or more of multiple types of RS including channel state information RS (CSI-RS) and demodulation RS (DMRS)—see also document and standard [1].

A gNB transmits a synchronization signal and primary broadcast channel block (SS/PBCH block), or SSB for brevity, for UEs to obtain system information and perform synchronization and measurements for signals transmitted by the gNB as described in documents and standards [1] and [3]. A CSI-RS is primarily intended for UEs to perform measurements and provide channel state information (CSI) to the gNB 102. For channel measurement, non-zero power CSI-RS (NZP CSI-RS) resources are used. Measurements included are for obtaining CSI and pathloss or reference signal received power (RSRP).

For interference measurement reports (INRs), CSI interference measurement (CSI-IM) resources associated with a zero power CSI-RS (ZP CSI-RS) configuration are used (see also document and standard [3]). A CSI process consists of NZP CSI-RS and CSI-IM resources. A UE can determine CSI-RS transmission parameters through DL control signaling or higher layer signaling, such as RRC signaling from a gNB (see also document and standard [6]). Transmission instances of a CSI-RS can be indicated by DL control signaling or configured by higher layer signaling. A demodulation reference signal (DM-RS) is transmitted only in the BW of a respective PDCCH or PDSCH, and a UE can use the DM-RS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access (see also documents and standards [1] and [3]). A UE transmits data information or UCI through a respective physical UL shared channel (PUSCH) or a PUCCH. A PUSCH or a PUCCH can be transmitted over a variable number of slot symbols including one slot symbol. When a UE simultaneously transmits data information and UCI, the UE 116 can multiplex both in a PUSCH or transmit both a PUSCH with data information and a PUCCH with UCI as described in document and standard [5].

UCI includes hybrid automatic repeat request acknowledgment (HARQ-ACK) information, indicating correct or incorrect detection of data transport blocks (TBs) in a PDSCH, scheduling request (SR) indicating whether a UE has data in its buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of the largest modulation and coding scheme (MCS) for the UE 116 to detect a data TB with a predetermined block error rate (BLER), such as a 10% BLER, of a precoding matrix indicator (PMI) informing a gNB how to combine signals from multiple transmitter antennas in accordance with a MIMO transmission principle, of a rank indicator (RI) indicating a transmission rank for a PDSCH, and of a CSI-RS resource indicator (CRI) informing of a CSI-RS resource the UE 116 used to obtain the CSI report.

UL RS includes DMRS and SRS. DMRS is transmitted only in a BW of a respective PUSCH or PUCCH transmission. A gNB can use a DMRS to demodulate information in a respective PUSCH or PUCCH. A UE transmits SRS to provide a gNB with an UL CSI and, for a TDD system, an SRS transmission can also provide a PMI for DL transmission. Additionally, in order to establish synchronization or an initial higher layer connection with a gNB, a UE can transmit a physical random access channel (PRACH, see also documents and standards [3] and [4]).

When a UE transmits a PUCCH on active UL BWP b of carrier f in the primary cell c using a PUCCH power control adjustment state with index l, the UE 116 determines the PUCCH transmission power P_{PUCCH,b,f,c}(i, qᵤ, q_{d},l) in PUCCH transmission occasion i as a minimum value between a configured maximum power for carrier f of primary cell c in PUCCH transmission occasion i,P_{CMAX,f,c}(i) and a power provided according to Equation 1 where the corresponding parameters are described in document and standard [3]. A power determination for a PUSCH or SRS transmission is also described in document and standard [3] and corresponding descriptions are omitted in the disclosure for brevity.

P_{PUCCH,b,f,c}(i,qᵤ,q_{d},l)=P_{O}_{_{PUCCH}}_{,b,f,c}(qᵤ)+10 log₁₀(2^{μ}·M_{RB,b,f}^{PUCCH}(i))+PL_{b,f,p}(q_{d})+ΔF_{PUCCH}(F)+Δ_{TF,b,f,c}(i)+g_{b,f,c}(i,l)[dBm] (Equation 1)

A UE can be configured for operation with carrier aggregation (CA) for PDSCH receptions over multiple cells (DL CA) or for PUSCH transmissions over multiple cells (UL CA). The UE 116 can also be configured with multiple transmission-reception points (TRPs) per cell via indication (or absence of indication) of a coresetPoolIndex for control resource sets (CORESETs) where the UE 116 receives PDCCH/PDSCH from a corresponding TRP as described in documents and standards [3] and [4].

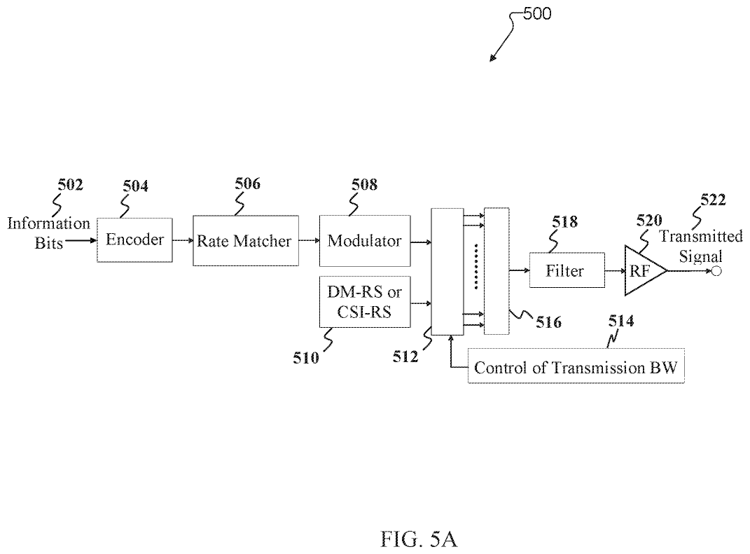

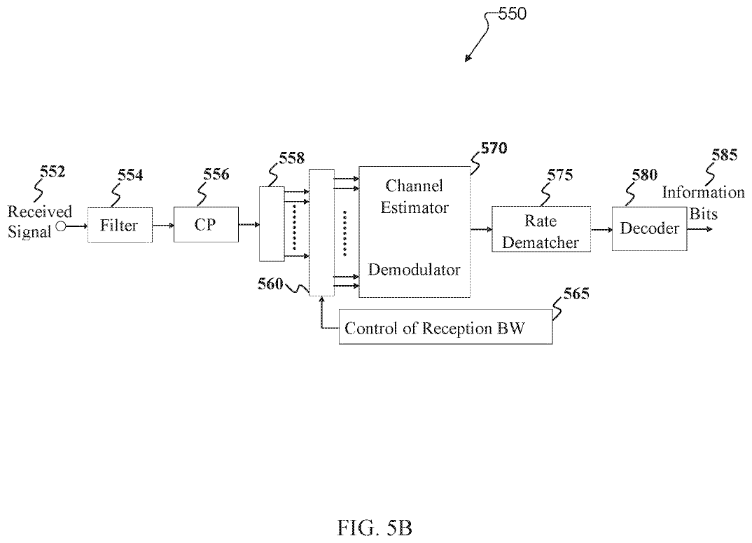

FIG. 5A and FIG. 5B illustrate an example of a receiver and transmit structures 500 and 550, respectively, using orthogonal frequency-division multiplexing (OFDM) according to embodiments of the present disclosure. For example, a transmitter structure 500 may be described as being implemented in a gNB (such as gNB 102), while a receiver structure 550 may be described as being implemented in a UE (such as UE 116). Structures 500 and 550 are for illustration only and other embodiments can be used without departing from the scope of the present disclosure.

As illustrated in FIG. 5A, information bits, such as DCI bits or data bits 502, are encoded by encoder 504, a rate matched to assigned time/frequency resources by rate matcher 506, and modulated by modulator 508. Subsequently, modulated encoded symbols and DM-RS or CSI-RS 510 are mapped to REs 512 by RE mapping unit 514, an inverse fast Fourier transform (IFFT) is performed by filter 516, a cyclic prefix (CP) is added by CP insertion unit 518, and a resulting signal is filtered by filter 520 and transmitted by a radio frequency (RF) unit 522.

As illustrated in FIG. 5B, a received signal 552 is filtered by filter 554, a CP removal unit removes a CP 556, a filter 558 applies a fast Fourier transform (FFT), RE de-mapping unit 560 de-maps REs selected by BW selector unit 565, received symbols are demodulated by a channel estimator and a demodulator unit 570, a rate de-matcher 575 restores a rate matching, and a decoder 580 decodes the resulting bits to provide information bits 585.

Embodiments of the present disclosure recognize that network energy savings are becoming a performance indicator of greater importance for networks as the energy cost represents a substantial portion of the overall operating cost while an increasing demand for applications with higher data rates requires the use of more antennas and bands which in turn requires a higher energy consumption and has a larger environmental impact. To reduce energy consumption, a network should be able to adapt operation according to traffic conditions and operate in different network energy saving (NES) modes or network (NW) operation states on a cell. A NW operation state may include one or more operation states on respective one or more groups of cells of the NW. A group of cells includes one or more cells.

In one example, in the absence of UL/DL traffic, a network can reduce operation in time/frequency/spatial/power domains to a minimal one necessary for UEs to maintain an RRC connection to a serving gNB while in the presence of UL/DL traffic, the NW can change a NW operation state to one corresponding to the traffic characteristics. Thus, the network 130 can operate in various operating states on a cell, for example, according to NW energy savings and for servicing required traffic. In another example, the network 130 can use a number of NW operation states, and different NW operation states, or simply different states, for the network 130 can be associated with the transmission of specific signaling or to monitoring/reception of specific signaling by a serving gNB or by a UE, or can be associated to specific characteristics of transmissions and/or receptions, such as a periodicity or a transmit power.

For example, a first NW operation state can correspond to the use of all/most resources in one or more of time/frequency/spatial/power domains by a serving gNB. A second NW operation state can correspond to minimal or no use of any such resources while intermediate states can correspond to reduced utilization of most such resources such as, for example, support of transmissions or receptions of only a subset of possible signals/channels or support of transmissions/receptions in non-consecutive time intervals or in a bandwidth that is smaller than a maximum bandwidth.

Present networks have limited capability to adapt an operation state in one or more of the time/frequency/spatial/power domains. For example, in NR, there are transmissions or receptions by a serving gNB that are expected by UEs, such as transmissions of SS/PBCH blocks or system information or of CSI-RS indicated by higher layers, or receptions of PRACH or SRS indicated by higher layers. Reconfiguration of a NW operation state involves higher layer signaling by a system information block (SIB) or by UE-specific RRC. That is a slow process and requires substantial signaling overhead, particularly for UE-specific RRC signaling. For example, it is currently not practical or possible for a network in typical deployments to enter an energy saving state where the network 130 does not transmit or receive due to low traffic as, in order to obtain material energy savings, the network 130 needs to suspend transmissions or receptions for several tens of milliseconds and preferably for even longer time periods. A similar inability exists for suspending transmission or receptions for shorter time periods as a serving gNB may need to transmit SS/PBCH blocks every 5 msec and, in TDD systems with UL-DL configurations having few UL symbols in a period, the serving gNB may need to receive PRACH or SRS in most UL symbols in a period.

In present NWs, an adaptation of a NW operation state is typically over long time periods, such as for off-peak hours when an amount of served traffic is small and for peak hours when an amount of served traffic is large. Therefore, a capability of a gNB to improve service by fast adaptation of a NW operation state to the traffic types and load, or to save energy by switching to a state that requires less energy consumption when an impact on service quality would be limited or none, is currently limited as there are no procedures for a serving gNB to perform a fast adaptation of a NW operation state, with small signaling overhead, while simultaneously informing all UEs.

The general principle for adaptation of NW operation states on a cell by physical layer signaling includes a serving gNB indicating to a UE a set of NW operation states on the cell by higher layer signaling, such as by a SIB or UE-specific RRC signaling, and transmitting a PDCCH that provides a DCI format, referred to as DCI format 2_8 in the disclosure, indicating one or more indexes to the set of NW operation states on the cell for the UE 116 to determine an update of NW operation states. A NW operation state may include one or more operation states on respective one or more groups of cells of the NW. A group of cells includes one or more cells.

For example, in the power domain, a first NW operation state on a cell can be associated with a first value of parameter ss-PBCH-BlockPower providing an average energy per resource element (EPRE) with secondary synchronization signals (SSS) in dBm, and a second NW operation state can be associated with a second value of a parameter ss-PBCH-BlockPower. For example, first and second NW operation states on one or more cells can be respectively associated with first and second values of parameter powerControlOffsetSS that provides a power offset (in dB) of non-zero power (NZP) CSI-RS RE to SSS RE.

For example, in the frequency domain, first and second NW operation states on one or more cells can be respectively associated with first and second values of a parameter locationAndBandwidth that indicates a frequency domain location and a bandwidth for receptions or transmissions by UEs.

For example, in the spatial domain, first and second NW operation states on one or more cells can be respectively associated with first and second values of a parameter maxMIMO-Layers that indicates a maximum number of MIMO layers to be used for PDSCH receptions by a UE in the associated active DL BWP, or with first and second values of a parameter nrOfAntennaPorts that indicates a number of antenna ports to be used for codebook determination for PDSCH receptions, or with first and second values of a parameter activeCoresetPoolIndex that coresetPoolIndex values for PDCCH transmissions in corresponding CORESETs and UEs can skip PDCCH receptions in a CORESET with coresetPoolIndex value that is not indicated by active CoresetPoolIndex.

For example, in the time domain, first and second NW operation states on one or more cells can be respectively associated with first and second values of a parameter ssb-PeriodicnyServingCell that indicates a transmission periodicity in milliseconds for SS/PBCH blocks, with first and second values of a parameter ssb-PositionslnBurst that indicates time domain positions of SS/PBCH blocks in a SS/PBCH block transmission burst, or with first and second values of a parameter groupPresence that indicates groups of SS/PBCH blocks, such as groups of four SS/PBCH blocks with consecutive indexes, that are transmitted.

A serving gNB can provide a UE with one or more search space sets to monitor PDCCH for detection of a DCI format 2_8 that indicates NW operation states as described in the subsequent embodiments of the present disclosure. The search space sets for DCI format 2_8 can be separate from other search space for other DCI formats that the serving gNB provides to the UE 116 or some or all search space sets can be common and the UE 116 can monitor PDCCH for the detection of both the DCI format 2_8 that indicates NW operation states and for other DCI formats providing information for scheduling PDSCH receptions, PUSCH transmissions, SRS transmissions, or providing other control information for the UE 116 to adjust parameters related to transmissions or receptions. The search space sets can be CSS sets or USS sets. When the search space sets are CSS sets, a serving gNB can indicate the search space sets associated with DCI format 2_8 through higher layer signaling in a SIB or through UE-specific RRC signaling. A UE can monitor PDCCH for detection of DCI format 2_8 both in the RRC CONNECTED state and in the RRC_INACTIVE state according to the corresponding search space sets and discontinuous reception (DRX) operation may not apply for PDCCH receptions that provide DCI format 2_8.

A UE may receive PDCCHs providing DCI format 2_8 in an active DL BWP. Alternatively, a UE may receive PDCCHs providing DCI format 2_8 in an initial DL BWP that was used by all UEs (or an initial DL BWP that was used by all UEs that support a feature of adaptation of NW operation states) to perform initial access and establish RRC connection with a serving gNB. The latter option enables a single PDCCH transmission with DCI format 2_8 from the serving gNB to all UEs because the initial DL BWP is common to all UEs, while the former option avoids a BWP switching delay because a UE receives PDCCHs providing DCI format 2_8 in the active DL BWP. It is also possible that the serving gNB indicates the DL BWP for PDCCH receptions that provide DCI format 2_8 through higher layer signaling, for example in a SIB.

A UE can request a transition from one network operating state to another operating state. For example, when a network operates in a state where the network 130 does not receive and a UE has data to transmit, the UE 116 can send a state transition request (STR) signal to the gNB 102 requesting the gNB 102 to transition to an operating state where the UE 116 can obtain service such as to be scheduled PUSCH transmissions. If a signal/channel transmission providing STR information by a UE is supported when a serving gNB operates in a sleep state, that is a state without using time/frequency/spatial/power resources, the STR may also be referred to as a UE-initiated wake-up-signal (WUS) for the gNB 102. In such cases, the STR may also be provided through a physical random access channel (PRACH). In the simplest form, an STR signal transmission can be based on on-off keying modulation where a transmission indicates a request to a NW operation state transition and the absence of transmission indicates no such request. For example, an STR can be provided by a PUCCH transmission similar to a scheduling request (SR) or similar to a PRACH as described in documents and standards [1] and [3].

The STR signal transmission calls for high reliability. One reason for high reliability is that such transmission would be infrequent because, in typical deployments, a transition from a NW operation state without using time/frequency/spatial/power resources to a NW operation state with the use of time/frequency/spatial/power resources, or generally a transition between NW operation states with different uses of time/frequency/spatial/power resources, initiated by the UE 116, happens when the UE 116 has an importance to transmit or receive. Infrequent NW state transitions allow the NW to remain in a NW energy saving state longer, as required for maximizing energy savings, and to avoid additional signaling overhead that causes more energy consumption for the network 130 and limits an ability of UEs for power savings by entering a sleep mode and skipping PDCCH receptions. To avoid that, the gNB 102 monitors the reception of a channel, such as PUCCH or PRACH, for STR too frequently, the periodicity of the channel can be indicated to be a large value that is a trade-off between network energy savings (and UE power savings) and UE experienced service at least with respect to latency. For example, the periodicity of the channel transmission can be larger than the periodicity of PUCCH transmissions for a UE to indicate a positive SR.

If a gNB fails to correctly decode a channel providing STR from a UE, the gNB 102 would be unaware of the UE 116's request to transmit or receive and that can have detrimental effects on the quality of service and UE power consumption as a UE may start to monitor PDCCH when no transmissions/receptions of data would be scheduled. For example, if the UE 116 transmits a channel with STR to request a transition to a NW operating state that supports transmissions and receptions, because the UE 116 has latency sensitive traffic to transmit, and the channel transmission is not received/identified by the gNB 102, the UE 116 not only cannot be scheduled but an opportunity to transmit again the channel may occur after a time interval that is too long based on the traffic requirements. Also in case the gNB 102 fails to correctly receive/identify a channel transmission from the UE 116 that provides STR requesting the network 130 to transition to a less active state, for example, because of UE-specific information such as an indoor location not supporting high data rates, the gNB 102 can miss an opportunity to transition to an operating state with lower energy consumption.

A UE can provide STR information in a PUCCH transmission that also provides other UCI such as HARQ-ACK information in response to detecting DCI formats scheduling PDSCH receptions or having associated HARQ-ACK information without scheduling PDSCH receptions, and/or SR information or CSI. STR information may have a different reliability requirement than other UCI because of the implications of a missed detection of the STR information on the network 130 energy savings and the quality of service for a UE contemplating PUCCH transmission opportunities with STR may be infrequent. For example, the STR information can have a BLER that is smaller than a BLER of other UCI. It is also possible that different STR information may need to have different reception reliability. For example, STR information indicating to a serving gNB to adapt a NW operation state from one with higher utilization of time/frequency/spatial/power resources to one with lower utilization may have a smaller reliability requirement than STR information indicating the reverse. For example, STR information indicating to the serving gNB that the UE 116 has data to transmit may call for larger reception reliability when the data is latency-sensitive than when the data is latency-tolerant.

In order to achieve different reliability requirements for STR information, a determination of a power for a corresponding PUCCH transmission can be based on a separate configuration than for a PUCCH transmission with UCI. Also, as a UE may not have recent PUCCH transmissions before a PUCCH transmission providing STR information, the use of prior transmit power control commands for the determination of a corresponding power may be detrimental as it may not accurately capture current short-term channel fading characteristics.

An impact from the absence of frequent TPC commands for a PUCCH transmission from a UE may be mitigated by the use of TPC commands for other transmissions on the same cell by the UE 116, such as for PUSCH or SRS, because the TPC commands primarily intend to compensate for short term fading characteristics. It is also possible that a serving gNB may issue a TPC command that increases or decreases a PUSCH transmission power relative to the one required to account for short term fading for example because the gNB 102 may want to support a larger or smaller MCS for a target BLER, respectively, or because the gNB 102 may want to target a smaller or larger BLER for a given MCS, respectively. However, it can be under the control of the serving gNB whether a TPC command associated with the determination for a power of a PUSCH or SRS transmission by the UE 116 is also used by the UE 116 to determine a power for a PUCCH transmission. The same applies to using a TPC command associated with the determination of a power for a PUCCH transmission by the UE 116 to also determine a power for a PUSCH transmission or a SRS transmission by the UE 116, or using a TPC command associated with the determination of a power for a SRS transmission by the UE 116 to also determine a power for a PUSCH transmission or a PUCCH transmission by the UE 116. For brevity, a PUCCH transmission is taken into account as a reference. Therefore, there is a need to enable a determination for a power of a PUCCH transmission with STR information independently of a determination for a power of a PUCCH transmission with UCI.

There is another need to enable the use of a closed-loop power control component based on TPC commands for determining a power for a PUCCH transmission with STR information from a UE based on conditions related to other transmissions from the UE 116.

Finally, there is a need to enable the utilization of TPC commands for more than one of PUSCH, PUCCH, and SRS transmissions towards a power determination for one of PUSCH, PUCCH, and SRS.

Throughout the disclosure, a NW operation state on a cell is also referred as a NW operation mode or NW operation configuration. The terms “NW operation state”, “NW operation mode”, or “NW operation configuration” are used interchangeably in this disclosure to refer to a network operation that may be dynamically adapted in order to save energy and/or based on the traffic types and load, so that the network may operate in more than one state.

In the following, Equation 1 is used as a reference for described parameters and, unless otherwise noted, corresponding operations and determinations are as described in document and standard [3]. In the following, CSI-RS resources are NZP CSI-RS resources.

If a PUCCH transmission includes UCI and STR information, the payload of STR information can be added to the UCI payload in the determination of Δ_{F}_{_{PUCCH}}(F) or Δ_{TF,b,f,c}(i) as described in document and standard [3]. If the PUCCH transmission does not include UCI and includes STR information, the payload of STR information is used to determine A_{F}_{_{PUCCH}}(F) or Δ_{TF,b,f,c}(i).

P_{O_PUCCH,b,f,c} is a parameter configured by a gNB and composed of the sum of a component P_{O_NOMINAL,PUCCH}, provided by a SIB for carrier f of primary cell c and, and a component P_{O_UE_PUCCH}(qᵤ) provided by UE-specific RRC signaling for active UL BWP b of carrier f of primary cell c, where 0≤qᵤ<Qᵤ and Qᵤ is a size for a set of P_{O_UE_PUCCH} values provided by higher layer parameters. The set of P_{O_UE_PUCCH}(qᵤ) values can be provided by p0-PUCCH-Value in p0-Set as described in document and standard [6]. If p0-Set is not provided to the UE 116, P_{O_UE_PUCCH}(qᵤ)=0.

In a first approach to enable independent setting of a power for a PUCCH transmission with STR information then a power for a PUCCH transmission with UCI, a serving gNB can provide a separate value of P_{O_NOMINAL,PUCCH}, referred to as P_{O_NOMINAL,PUCCH,STR} by a SIB. Alternatively, P_{O_NOMINAL,PUCCH,STR} can be an offset to P_{O_NOMINAL,PUCCH} and the UE 116 sets P_{O_NOMINAL,PUCCH} to P_{O_NOMINAL,PUCCH}+P_{O_NOMINAL,PUCCH,STR} when the UE 116 transmits a PUCCH with STR information. Further, the use of P_{O_UE_PUCCH}(qᵤ) can be disabled (P_{O_UE_PUCCH}(qᵤ)=0), where 0≤qᵤ<Qᵤ is a size for a set of P_{O_UE_PUCCH} values provided by maxNrofPUCCH-P0-PerSet. Then, P_{O_PUCCH,b,f,c} for a PUCCH transmission with STR information is the same for all UEs and is set separately than P_{O_PUCCH,b,f,c} for PUCCH transmission with UCI by a UE.

In a second approach to enable independent setting of a power for a PUCCH transmission with STR information then for a PUCCH transmission with UCI, a serving gNB can provide an additional set of one or more values for a P_{O_UE_PUCCH} STR parameter. A value of P_{O_UE_PUCCH_STR}(qᵤ) can be used to replace the P_{O_UE_PUCCH} value in the determination of P_{O_PUCCH,b,f,c} for a PUCCH that provides STR information in order to account for a different reliability requirement for the PUCCH transmission with STR and without STR information. Alternatively, P_{O_UE_PUCCH,STR} can be an offset to P_{O_UE_PUCCH} and the UE 116 can replace P_{O_UE_PUCCH} with P_{O_UE_PUCCH} P_{O_UE_PUCCH} STR for the determination of a power for a PUCCH transmission that provides STR information.

If the UE 116 is provided PUCCH-SpatialRelationInfo, the UE 116 obtains a mapping, by an index provided by p0 PUCCH-Id, between a set of PUCCHSpatialRelationInfold values and a set of p0-PUCCH-Value values. If the UE 116 is provided with more than one value for PUCCH SpatialRelationInfold and the UE 116 receives an activation command, as described in document and standard [5], indicating a value of PUCCHSpatialRelationInfold, the UE 116 determines the p0-PUCCH-Value value through the link to a corresponding p0-PUCCH-Id index. the UE 116 applies the activation command in the first slot that is after slot k+3·Nₛₗₒₜ^{subframe,μ} where k is the slot where the UE 116 would transmit a PUCCH with STR information and with HARQ-ACK information for the PDSCH providing the activation command and μ is the SCS configuration for the PUCCH.

If the UE 116 is provided more than one set of power control parameters, and the UE 116 receives an activation command, as described in document and standard [5], indicating one or two of the more than one set of power control parameters, the UE 116 determines p0-PUCCH-Value value according to the corresponding one or two sets of power control parameters. The UE 116 applies the activation command in the first slot that is after slot k+3 Nₛₗₒₜ^{subframe,μ} where k is the slot where the UE 116 would transmit a PUCCH with STR information and with HARQ-ACK information for the PDSCH or a PUCCH with STR information providing the activation command and μ is the SCS configuration for the PUCCH.

The PL_{b,f,c}(q_{d}) parameter is a downlink pathloss estimate in dB calculated by the UE 116 using RS resource index q_{d} for the active DL BWP b of carrier f of the primary cell c. When the UE 116 is provided a number of RS resource indexes, the UE 116 calculates PL_{b,f,c}(q_{d}) using RS resource with indexes q_{d}, where 0≤q_{d}<Q_{d} and Q_{d} is a size for a set of RS resources provided by maxNrofPUCCH-PathlossReferenceRSs. The set of RS resources is provided by pathlossReferenceRSs. The set of RS resources can include one or both of a set of SS/PBCH block indexes, each provided by ssb-Index in PUCCH-PathlossReferenceRS when a value of a corresponding PUCCHPathlossReferenceRS-Id maps to a SS/PBCH block index, and a set of CSI-RS resource indexes, each provided by csi-RS-Index when a value of a corresponding PUCCH PathlossReferenceRS-Id maps to a CSI-RS resource index. The UE 116 identifies a RS resource in the set of RS resources to correspond either to a SS/PBCH block index or to a CSI-RS resource index as provided by PUCCHPathlossReferenceRS-Id in PUCCH-PathlossReferenceRS.

When the UE 116 is provided pathlossReferenceRSs and PUCCH-SpatialRelationInfo, the UE 116 obtains a mapping, by indexes provided by corresponding values of PUCCH PathlossReferenceRS-Id, between a set of PUCCHSpatialRelationInfold values and a set of referenceSignal values provided by PUCCH-PathlossReferenceRS.

The UE 116 can be provided a separate index for PUCCHPathlossReferenceRS-Id for an SS/PBCH block or a CSI-RS to calculate the downlink pathloss estimate for a PUCCH transmission with STR information. One reason is that when the UE 116 is in RRC CONNECTED state and is scheduled by a serving gNB, the serving gNB typically transmits a first CSI-RS associated with a respective first CSI-RS resource index and can indicate to the UE 116 to use corresponding first CSI-RS resources to measure a pathloss. For example, the first CSI-RS resources can be ones associated with/correspond to a beam/spatial filter the UE 116 uses to transmit to the serving gNB. However, when the network 130 operates in a different state, such as a low energy state, the first CSI-RS resources may not be used as the gNB 102 may not be transmitting with narrow beams and instead, for example in order to conserve energy, may be transmitting using fewer and wider beams. For example, the UE 116 may need to use second CSI-RS resources associated with a wider beam to calculate a pathloss when the network 130 operates in a low energy state. In such case, the UE 116 also adjusts a spatial filter used for a PUCCH transmission providing STR information according to the second CSI-RS resources. For that reason, the UE 116 can be indicated to use different CSI-RS resources to measure pathloss for determining a power of a PUCCH transmission with STR information than for determining a power of a PUCCH transmission with UCI information.

The RS resources that a UE uses to calculate pathloss to determine a power for a PUCCH transmission with STR information can be from the same set of SS/PBCH block indexes or CSI-RS resource indexes as for calculating a pathloss for a PUCCH transmission with UCI, or the UE 116 can be provided a separate set of RS resources, for example, by pathlossReferenceRSs_STR. In the latter case, the UE 116 can also be provided a mapping between RS resources in pathlossReferenceRSs for PUCCH transmission with UCI and RS resources in pathlossReferenceRSs_STR and can determine the RS resource from pathlossReferenceRSs_STR to use for calculating a pathloss for a PUCCH transmission with STR information based on the mapping with an associated RS resource from pathlossReferenceRSs that the UE 116 is indicated for a PUCCH transmission with UCI information. For example, four RS resources from pathlossReferenceRSs that are associated with respective narrower beams can map to one RS resource from pathlossReferenceRSs_STR that is associated with a wider beam.

When a network is in a sleep state and a serving gNB does not transmit any signals, a UE cannot measure a pathloss for transmission of a PUCCH with STR information. In a first approach, the UE 116 can use a last pathloss estimate that the UE 116 calculated before the gNB 102 suspending signal transmissions. In a second approach, to improve robustness to UE 116 mobility in case the gNB 102 was transmitting using multiple beams and as a suitable beam for the UE 116 may have changed since the last pathloss measurement by the UE 116, the UE 116 can be indicated to use a last pathloss measurement that the UE 116 calculated based on an SS/PBCH block. An index for the SS/PBCH block can also be indicated by the gNB 102 to the UE 116, at least in case the UE 116 used an index of CSI-RS resources to measure a pathloss for determining a power of a PUCCH transmission with UCI information and uses the pathloss measurement based on the SS/PBCH block to determine a power of a PUCCH transmission with STR information.

In a third approach, a serving gNB may transmit SS/PBCH blocks before a transmission occasion for a PUCCH with STR information. For example, a periodicity of SS/PBCH blocks can be the same as, or a multiple of, a periodicity of transmission occasions for PUCCH with STR information. The UE 116 can use a corresponding pathloss measurement to determine a power of the PUCCH transmission. The SS/PBCH block can also be a reduced one, for example, one that does not include PBCH transmission and includes the transmission of secondary synchronization signals. The periodicity of transmissions for SS/PBCH blocks or of synchronization signals can be a multiple of the periodicity for transmissions of SS/PBCH blocks when the gNB 102 operates in a different state, such as in a full-service/maximum state. A transmission power of SS/PBCH blocks or synchronization signals can be the same or different for different NW operation states.

In a fourth approach, similar to the third approach, a serving gNB may transmit CSI-RS, such as a tracking RS, for example, before a transmission occasion for a PUCCH with STR information, and the UE 116 can use a corresponding pathloss measurement to determine a power of the PUCCH transmission. The UE 116 can additionally use receptions of SS/PBCH blocks or of CSI-RS resources before the PUCCH transmission occasion to perform time and frequency synchronization. The indexes of the SS/PBCH blocks or of the CSI-RS resources that the UE 116 uses to calculate pathloss before the PUCCH transmission with STR information can be separately provided to the UE 116 by higher layers.

In a fifth approach, the UE 116 can measure pathloss based on a SS/PBCH block or on CSI-RS resources that the UE 116 receives on a cell that is different than the cell of the PUCCH transmission with STR information. The UE 116 can be provided apathlossReferenceLinking STR parameter that is separate from a pathlossReferenceLinking parameter used for PUCCH transmissions with UCI, as described in document and standard [3], to indicate a cell where a pathloss measurement by the UE 116, based on a SS/PBCH block or a CSI-RS, can be used by the UE 116 to determine a power of the PUCCH transmission with STR information. The cell indicated by pathlossReferenceLinking STR can be in a same band or in different bands than the cell where the UE 116 transmits the PUCCH. If the latter case, the UE 116 can additionally apply a scaling to the pathloss estimate based on the carrier frequency difference between the cell where the UE 116 measures the pathloss and the cell where the UE 116 transmits the PUCCH with the STR information. For example, free-space pathloss is proportional to the square of the carrier frequency, denoted by f_{PL}, the carrier frequency of the cell where the UE 116 measures pathloss, and by f_{PUCCH}, the carrier frequency where the UE 116 transmit the PUCCH. The pathloss measurement can be scaled by (f_{PUCCH}/f_{PL})².

In a sixth approach, a UE is provided transmission occasions and resources for PUCCH with STR information on more than one cell and the UE 116 determines the cell for the PUCCH transmission among cells where the gNB 102 transmits, and the UE 116 receives, SS/PBCH blocks or CSI-RS in order for the UE 116 to calculate a pathloss measurements. In case of multiple such cells exist, the UE 116 can select the cell with the lowest index such as a primary cell, the cell with the lowest carrier frequency, or the cell with the earliest transmission occasion for the PUCCH. The criterion for the UE 116 selection of a cell for the PUCCH transmission can be defined in the specifications of the system operation or left to the UE 116 implementation.

Approaches described herein are for determining a pathloss measurement, that is a PUCCH transmission with STR information. However, these methods can also be applied to any transmission from a UE before the serving gNB indicates a UE. For example, the index of an SS/PBCH block or CSI-RS resources can be obtained through UE-specific RRC signaling or a MAC CE to receive corresponding signaling for calculating the pathloss.

For example, after the gNB 102 receives the PUCCH with STR information and schedules a PUSCH transmission from a UE 116 or triggers a PUCCH transmission from the UE 116, for example, with HARQ-ACK information associated with PDCCH receptions, PDSCH receptions, or a SRS transmission, the UE 116 can use a same pathloss measurement as for a PUCCH transmission with STR information until the UE 116 is indicated by the gNB 102 an index of a SS/PBCH block or CSI-RS resources for corresponding pathloss measurements.

The approaches described herein can also be combined. For example, a UE transmits PUCCH with STR information on the primary cell, there is no reception of SS/PBCH blocks or of CSI-RS 116 on the primary cell, and the UE 116 measures a pathloss to determine a power for the PUCCH transmission with STR information based on receptions of SS/PBCH blocks or of CSI-RS resources on a secondary cell that can be indicated to the UE 116 or can be a secondary cell with receptions of SS/PBCH blocks or of CSI-RS resources having the smallest index among secondary cells for the UE 116, and so on. For example, the secondary cell can be a primary cell for another UE. Alternatively, the UE 116 can be provided resources for PUCCH transmission with STR information also on the secondary cell.

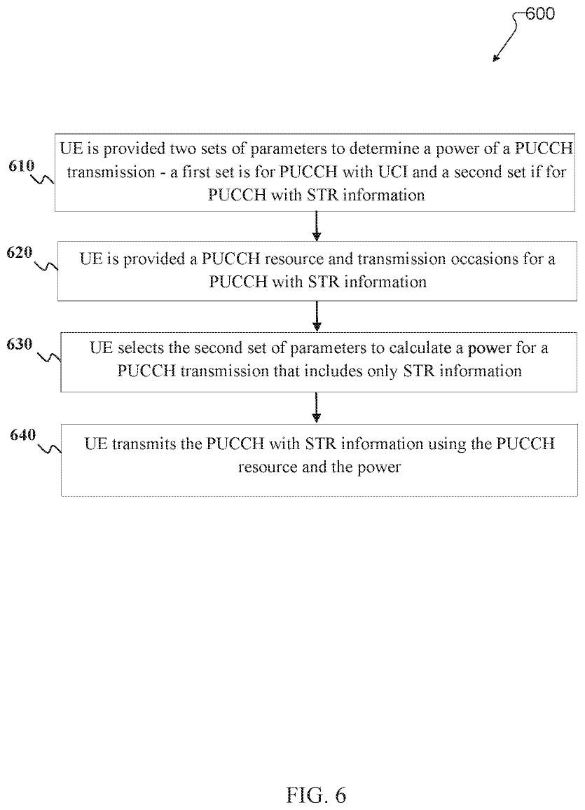

FIG. 6 illustrates an example of a flowchart of method 600 of a UE determining a power for a PUCCH transmission with STR information based on a set of parameters indicated for PUCCH with STR information according to embodiments of the present disclosure. For example, method 600 can be performed by any of the UEs 111-116 of FIG. 1, such as the UE 116 of FIG. 3, and a corresponding method can be performed by any of the BSs 101-103 of FIG. 3, such as BS 102 of FIG. 2. The method 600 is for illustration only and other embodiments can be used without departing from the scope of the present disclosure.

Beginning the method in step 610, A UE is provided by a serving gNB two sets of parameters for determining a power of a PUCCH transmission, wherein a first set is for PUCCH with UCI and a second set if for PUCCH with STR information. In step 620, the UE 116 is provided a PUCCH resource and transmissions occasions, such as a starting slot and a periodicity, for a PUCCH transmission with STR information. In step 630, the UE 116 selects the second set of parameters to determine a power when the PUCCH transmission includes STR information. The UE 116 transmits the PUCCH with STR information using the PUCCH resource and the power in step 640. The UE 116 may use one of the first set of parameters or the second set of parameters to determine a power for a PUCCH transmission that includes both UCI and STR information. The choice can be indicated by the serving gNB or defined in the specifications of the system operation, for example, the first set of parameters.

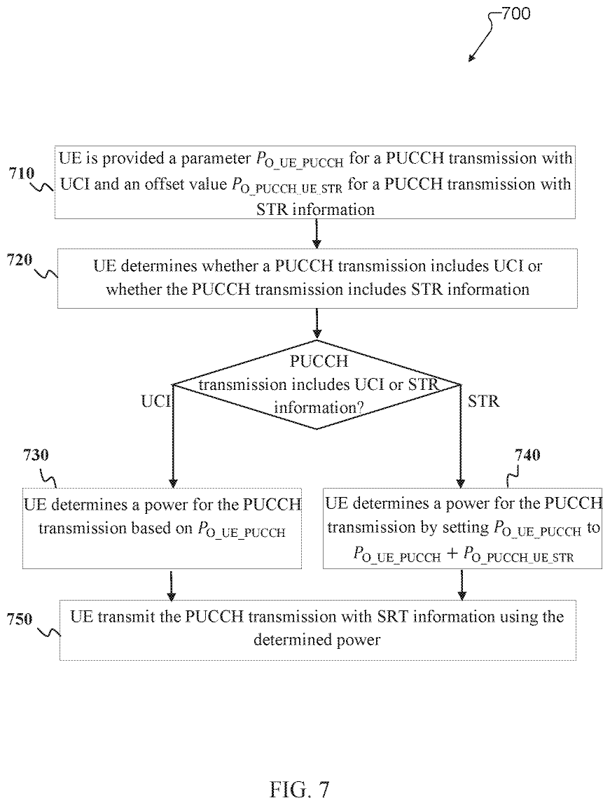

FIG. 7 illustrates an example of a flowchart of method 700 of a UE determining a nominal power for a PUCCH transmission depending on whether the PUCCH provides UCI or STR information according to embodiments of the present disclosure. For example, method 700 can be performed by any of the UEs 111-116 of FIG. 1, such as the UE 116 of FIG. 3. The method 700 is for illustration only and other embodiments can be used without departing from the scope of the present disclosure.

The method begins in step 710 when a UE is provided a parameter P_{O_UE_PUCCH} for a PUCCH transmission with UCI and an offset value P_{O_PUCCH_UE_STR} for a PUCCH transmission with STR information. The UE 116 then determines whether a PUCCH transmission includes UCI or whether the PUCCH transmission includes STR information P_{O_UE_PUCCH} in step 720. When the PUCCH transmission includes UCI, the UE 116 then determines a power for the PUCCH transmission based on P_{O_UE_PUCCH} in step 730. When the PUCCH transmission includes STR information, the UE 116 then determines a power for the PUCCH transmission by setting P_{O_UE_PUCCH} to P_{O_UE_PUCCH}+P_{O_PUCCH_UE_STR} in step 740. The UE 116 then transmits the PUCCH transmission with SRT information using the determined power in step 750. Although FIG. 7 takes into account that the UE 116 is provided P_{O_PUCCH_UE_STR}, similar descriptions apply when the UE 116 is instead provided P_{O_NOMINAL,PUCCH,STR} as an offset to P_{O_NOMINAL,PUCCH}.

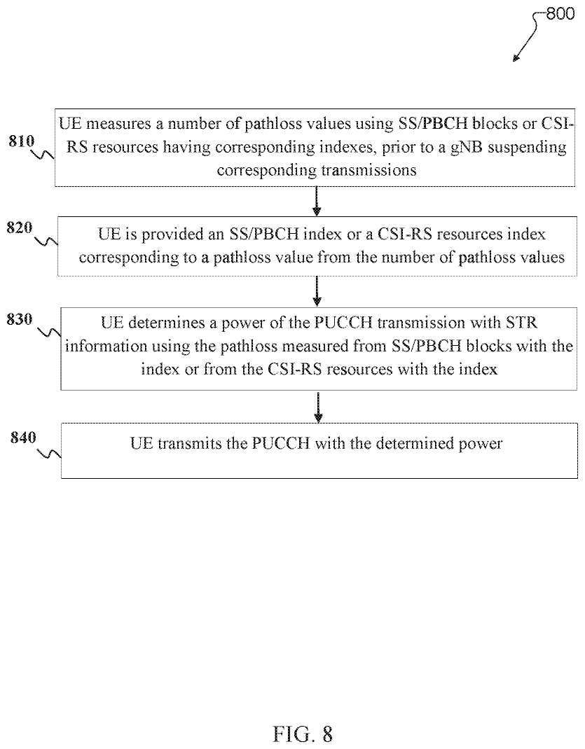

FIG. 8 illustrates an example of a flowchart of method 800 of a UE determining a power for a PUCCH transmission with STR information based on a pathloss calculated from a SS/PBCH block index provided by a gNB according to embodiments of the present disclosure. For example, method 800 can be performed by the UE 116 and, more particularly, in one or more of the transceivers 310. The method 800 is for illustration only and other embodiments can be used without departing from the scope of the present disclosure.

The method begins in step 810 with a UE measuring a number of pathloss values using SS/PBCH blocks or CSI-RS resources having corresponding indexes, before a gNB suspends transmissions of the SS/PBCH blocks or for the CSI-RS resources. The UE 116 is then provided an SS/PBCH index or a CSI-RS resources index corresponding to a pathloss value from the number of pathloss values in step 820. After the gNB 102 suspends transmissions of the SS/PBCH blocks or on the CSI-RS resources, the UE 116 then determines a power of the PUCCH transmission with STR information using the pathloss measured from SS/PBCH blocks with the index or from the CSI-RS resources with the index in step 830. The UE 116 transmits the PUCCH with the determined power in step 840.

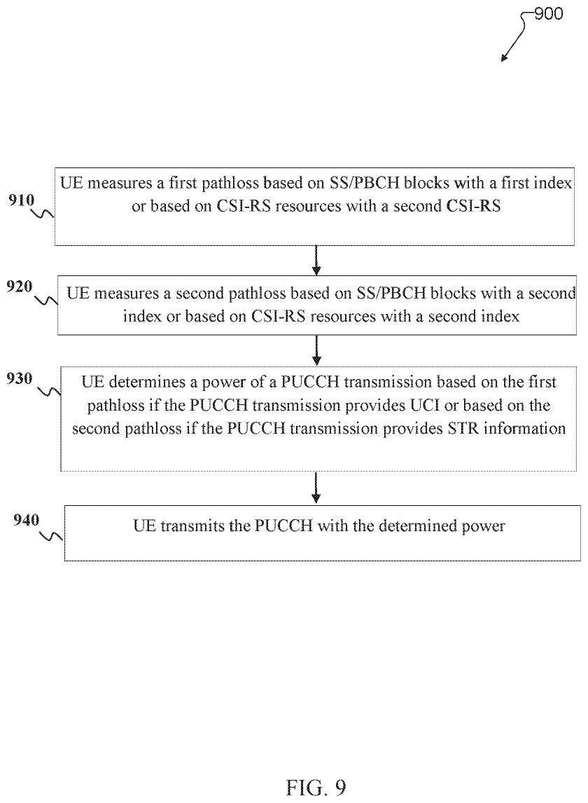

FIG. 9 illustrates an example of a method 900 of a flowchart of a UE determining a power for a PUCCH transmission depending on whether the PUCCH provides UCI or STR information according to embodiments of the present disclosure. For example, method 900 can be performed by the UE 116 and, more particularly, in processor 340. The method 900 is for illustration only and other embodiments can be used without departing from the scope of the present disclosure.

The method begins in step 910 with a UE measuring a first pathloss based on SS/PBCH blocks with a first index or based on CSI-RS resources with a first CSI-RS index, before a gNB suspending corresponding transmissions. The UE 116 then measures a second pathloss based on a SS/PBCH block with a second index or based on CSI-RS resources with a second index in step 920. The UE 116 then determines a power of a PUCCH transmission, wherein the power is calculated based on the first pathloss if the PUCCH transmission provides UCI or based on the second pathloss if the PUCCH transmission provides STR information in step 930. The UE 116 transmits the PUCCH with the determined power in step 940.

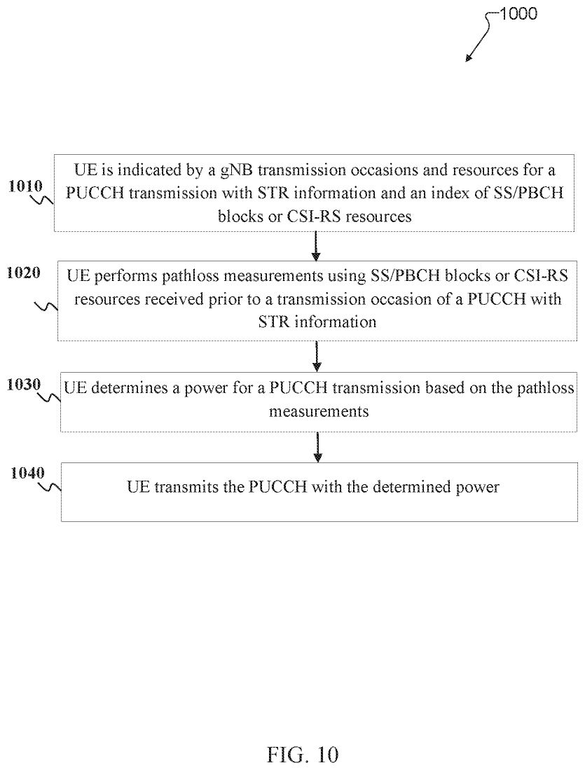

FIG. 10 illustrates an example of a flowchart of a UE determining a power for a PUCCH transmission with STR information based on pathloss measurements from SS/PBCH blocks or CSI-RS resources received before the PUCCH transmission according to embodiments of the present disclosure. For example, method 1000 may be performed by the UE 116 and, more particularly, in one or more of the transceivers 310 and/or processor 340. The method 1000 is for illustration only and other embodiments can be used without departing from the scope of the present disclosure.

The method begins in step 1010 when a UE is indicated by a gNB transmission occasions and resources for a PUCCH transmission with STR information and an index of SS/PBCH blocks or CSI-RS resources associated with a determination for a power of the PUCCH transmission. The UE 116 then measures pathloss using SS/PBCH blocks or CSI-RS resources received before a transmission occasion of a PUCCH with STR information in step 1020. The UE 116 then determines a power for a PUCCH transmission based on the pathloss measurements in step 1030. The UE 116 transmits the PUCCH with the determined power in step 1040.

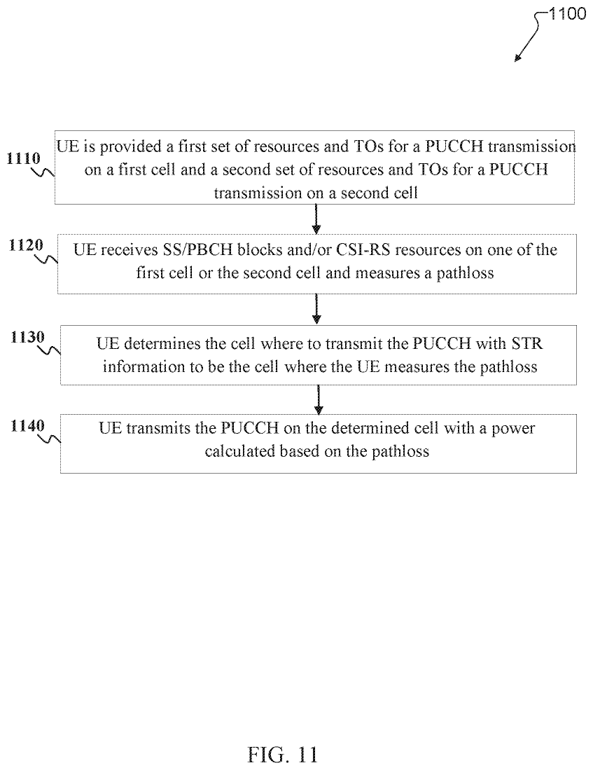

FIG. 11 illustrates an example of a flowchart of a method of a UE selecting a cell for PUCCH transmission with STR information according to embodiments of the present disclosure. For example, method 1100 can be executed by the UE 116 of FIG. 3. The method 1100 is for illustration only and other embodiments can be used without departing from the scope of the present disclosure.

The method begins in step 1110 when a UE is provided a first set of resources and time offsets (TOs) for a PUCCH transmission on a first cell and a second set of resources and TOs for a PUCCH transmission on a second cell in step 1110. The UE 116 receives SS/PBCH blocks and/or CSI-RS resources on one of the first cells or the second cell and measures a pathloss in step 1120. The UE 116 determines the cell where to transmit the PUCCH with STR information to be the cell where the UE measures the pathloss in step 1130. The UE 116 transmits the PUCCH on the determined cell with a power calculated based on the pathloss in step 1140.

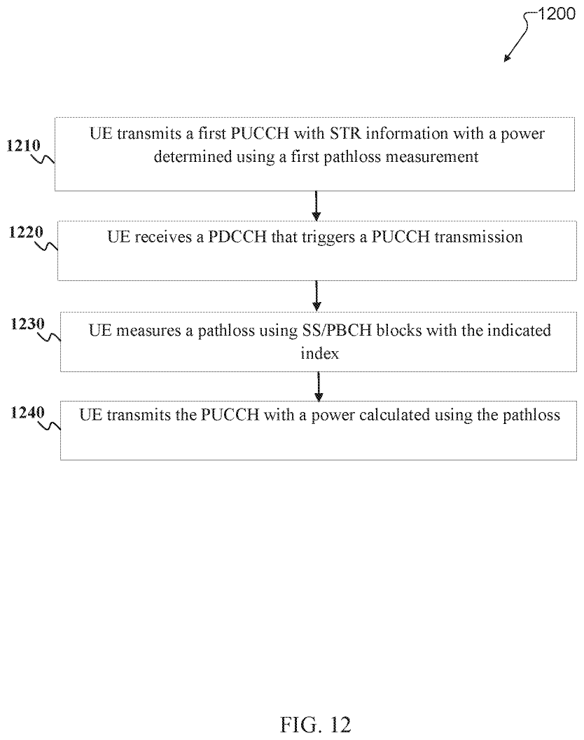

FIG. 12 illustrates an example of a flowchart of a method 1200 of a UE determining a pathloss measurement for a PUCCH transmission triggered by a PDCCH reception according to embodiments of the present disclosure. For example, method 1200 can be performed by the UE 116 of FIG. 3 and, more particularly, in one or more of the transceivers 310 and/or processor 340. The method 1200 is for illustration only and other embodiments can be used without departing from the scope of the present disclosure.

The method begins in step 1210 when a UE transmits a first PUCCH with STR information with a power determined using a first pathloss measurement. A UE then receives a PDCCH that triggers a PUCCH transmission in step 1220. The PDCCH may additionally provide an index of a SS/PBCH block or the index of the SS/PBCH block which can be provided in advance by RRC signaling and can also be associated with a TCI state of a CORESET used for the PDCCH reception. The UE 116 then measures a pathloss using SS/PBCH blocks with the indicated index in step 1230. The UE 116 then transmits the PUCCH with a power calculated using the pathloss in step 1240.

A determination of a power for a PUCCH transmission, for example, as described in document and standard [3], may exclude a CLPC adjustment state that is based on an accumulation of TPC commands because a UE may not have transmitted or received for a time period that is longer than a time period required for materially correlated short term channel fading characteristics and a value of the CLPC may then be outdated. A UE may also exclude the CLPC adjustment state when a RSRP changes beyond a threshold as that can reflect different channel conditions. For example, when a RSRP increases by a value larger than the threshold, such as when due to mobility transmissions from the UE 116 to the gNB 102 experience line-of-sight instead of shadowing, the CLPC adjustment state value may be too large leading to a large transmission power and inter-cell interference. It is also possible that whether the UE uses or not TPC commands for determining the power of the PUCCH transmission depends on the operation state of the serving gNB. For example, the UE uses TPC commands and/or updates the CLPC adjustment state if the serving gNB is not in a sleep state or in an operation state with limited functionalities to reduce energy consumption, otherwise the UE does not use TPC commands in such operation states.

A serving gNB can provide to a UE by higher layer signaling a time period. The higher layer signaling can be a SIB or can be UE-specific RRC signaling in order to reflect the mobility and channel experienced by each UE as the mobility affects short-term channel fading. For example, the time period can be in slots of a reference BWP, such as an initial DL or UL BWP, in slots of a reference numerology/SCS, or in absolute time such as milliseconds. The UE 116 sets to 0 the value of the CLPC adjustment state, denoted by g_{b,f,c}(i,l) in Equation 1, after the time period if the UE 116 has not received any TPC commands during the time period. The condition for setting the CLPC adjustment state to 0 can also entail that the UE 116 does not transmit during the time period.

In a first approach, a UE can be provided the time period in a set of parameters for the determination of a power for a PUCCH transmission. In a second approach, the time period can be common to all transmissions by a UE, such as for a PUSCH, PUCCH, or SRS, and be provided by a serving gNB separately of respective power control parameters.

A serving gNB can provide to a UE an RSRP threshold, or equivalently a pathloss threshold, for example in a SIB or by UE-specific RRC signaling. When the UE 116 measures an RSRP that is larger than, or smaller than, a previous RSRP measurement by the threshold, the UE 116 resets the CLPC adjustment state value to zero and updates the CLPC adjustment state value based on subsequent TPC command values for a corresponding channel transmission.

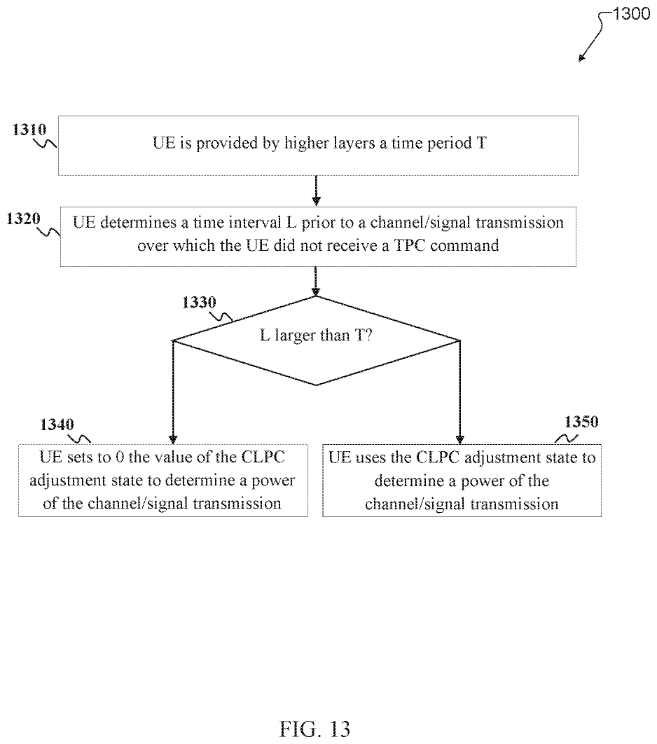

FIG. 13 illustrates an example of a flowchart of a method 1300 of a UE transmitting a channel/signal with a power calculated by including or not including a CLPC adjustment state according to embodiments of the present disclosure. For example, method 1300 can be performed by the UE 116 and, more particularly, by one or more of the transceivers 310, one or more of the antennas 305, and/or the processor 340. The method 1300 is for illustration only and other embodiments can be used without departing from the scope of the present disclosure.

The method begins in step 1310 with a UE that is provided, by higher layers, a time period T. The UE 116 then determines a time interval L before a channel/signal transmission over which the UE 116 did not receive a TPC command for the channel/signal transmission in step 1320. In step 1330, the UE 116 determines whether L is larger than T. When L is larger than T, the UE 116 sets to 0 the value of the CLPC adjustment state to determine a power for the channel/signal transmission in step 1340. Otherwise, the UE 116 uses the CLPC adjustment state to determine the power of the channel/signal transmission in step 1350.

Some or all TPC commands provided by a DCI format scheduling a PUSCH transmission, a DCI format scheduling a PDSCH reception and triggering a PUCCH transmission with associated HARQ-ACK information, a DCI format triggering an SRS transmission, a DCI format that does schedule a PUSCH, or trigger a PUCCH transmission, can be commonly used for determining a power of a PUSCH or PUCCH or SRS transmission. Such functionality can enable a UE to obtain more frequent TPC commands for determining a CLPC adjustment state value and; therefore, to more accurately control a power of a channel/signal transmission associated with the CLPC adjustment state and offer better link adaptation to transmissions by a UE. Such functionality can be enabled, based on a primary purpose of TPC commands, to track short-term channel variations due to fast fading that are common among channel/signals transmissions by the same UE.

A serving gNB can indicate to a UE, for example, by higher layer signaling, TPC commands and channels that a UE can jointly use corresponding TPC commands for determining a transmission power of a channel from the channels. For example, the gNB 102 can indicate to the UE 116 to use both TPC commands provided by DCI formats scheduling PUSCH transmissions and TPC commands provided by DCI formats scheduling PDSCH receptions to determine a power for a PUSCH transmission. Therefore, the UE 116 would use TPC commands provided by DCI formats scheduling PDSCH receptions, in addition to TPC commands provided by DCI formats scheduling PUSCH transmissions, in computing a CLPC adjustment state that is used for determining a PUSCH transmission power.

Further, instead of a UE being provided by the gNB 102 a first radio network temporary identifier (RNTI) for a DCI format that provides TPC commands for PUSCH transmissions from UEs (PUSCH-TPC-RNTI) and a second RNTI for a DCI format that provides TPC commands for PUCCH transmissions from UEs (PUCCH-TPC-RNTI), the UE 116 can be provided a single RNTI (TPC-RNTI) for such TPC commands. A common use of TPC commands can also be restricted to PUSCH, or PUCCH, transmissions that are configured by higher layers and do not apply to PUSCH, or PUCCH, transmissions that are scheduled/triggered by DCI formats.

The DCI format can indicate the use of a TPC command value for a CLPC adjustment state, which determines the transmission power of a channel that is not associated with the DCI format, such as, for example, a use of TPC command value in a DCI format scheduling a PDSCH reception in a CLPC adjustment state associated with a PUSCH transmission can be indicated by the DCI format.

For example, the DCI format scheduling a PDSCH reception or a PUSCH transmission can include a field of 1 bit indicating whether a TPC command can be used for a CLPC state associated with a PUSCH transmission or a PUCCH transmission, respectively.

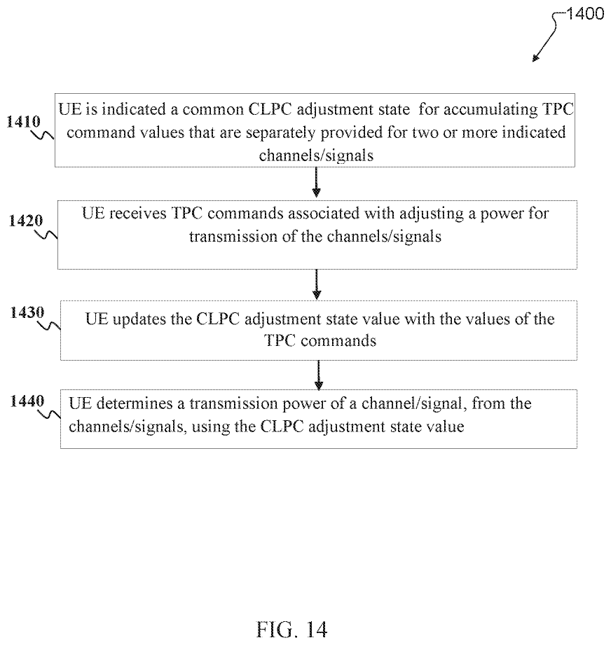

FIG. 14 illustrates an example of a flowchart of a method 1400 of a UE determining a transmission power of a channel/signal using a CLPC adjustment state according to embodiments of the present disclosure. For example, method 1400 may be performed by any of the UEs 111-116 of FIG. 1. The method 1400 is for illustration only and other embodiments can be used without departing from the scope of the present disclosure.

The method begins in step 1410 when a UE has indicated a common CLPC adjustment state for accumulating TPC command values that are separately provided for two or more indicated channels/signals. The UE 116 then receives TPC commands associated with adjusting a power for transmission of the channels/signals in step 1420. The UE 116 then updates the CLPC adjustment state value with the values of TPC commands in step 1430. The UE 116 then determines a transmission power of a channel/signal, from the channels/signals, using the CLPC adjustment state value in step 1440.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Any of the above variation embodiments can be utilized independently or in combination with at least one other variation embodiment.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive:
first information for a set of operation states for a set of cells, and
second information for a set of values for a power control parameter; and
a processor operably coupled to the transceiver, the processor configured to determine a first power for a transmission of a first physical uplink control channel (PUCCH) based on:
the first PUCCH including first information bits that indicate a first operation state from the set of operation states for a first cell from the set of cells, and
a first value from the set of values for the power control parameter,
wherein the transceiver is further configured to transmit the first PUCCH with the first power.

2. The UE of claim 1, wherein:
the transceiver is further configured to receive:
third information for a second operation state from the set of operation states for a primary cell from the set of cells, and
fourth information for a reference signal (RS) resource on a secondary cell from the set of cells;
the second operation state is associated with an absence of receptions of RSs on the primary cell;
the processor is further configured to determine a pathloss based on the RS resource;
the first power is based on the pathloss; and
transmission of the first PUCCH is on the primary cell.

3. The UE of claim 1, wherein:
the transceiver is further configured to receive third information for reception of synchronization signals on a second cell;
the third information indicates:
a first periodicity associated with a second operation state, from the set of operation states, on the second cell, and
a second periodicity associated with a third operation state, from the set of operation states, on the second cell;
the processor is further configured to determine:
the second operation state or the third operation state on the second cell, and
a pathloss based on reception of the synchronization signals according to the determined second or third operation state on the second cell;
the first power is based on the pathloss; and
transmission of the first PUCCH is on the second cell.

4. The UE of claim 1, wherein:
the processor is further configured to determine:
a second operation state, from the set of operation states, for a primary cell during the transmission of the first PUCCH,
the primary cell for the transmission of the first PUCCH when the second operation state is not a predetermined operation state, and
a secondary cell for the transmission of the first PUCCH when the second operation state is the predetermined operation state; and
transmission of the first PUCCH is on one of the primary cell or the secondary cell based on the determination of the primary or secondary cell.

5. The UE of claim 1, wherein:
the processor is further configured to determine a second power for a transmission of a second PUCCH based on:
the second PUCCH including second information bits that are not associated with an indication of an operation state, from the set of operation states, for a cell from the set of cells, and
a second value from the set of values for the power control parameter; and
the transceiver is further configured to transmit the second PUCCH with the second power.

6. The UE of claim 5, wherein:
the determination of the first power is not based on a transmit power control (TPC) command value, and
the determination of the second power is based on a number of TPC command values.

7. The UE of claim 1, wherein:
the transmission of the first PUCCH in on a primary cell,
the determination of the first power is based on a first number of transmit power control (TPC) command values when an operation state for the primary cell is the first operation state from the set of operation states, and
the determination of the first power is not based on a TPC command value when an operation state for the primary cell is not the first operation state.

8. A base station (BS) comprising:
a transceiver configured to transmit:
first information for a set of operation states for a set of cells, and
second information for a set of values for a power control parameter; and
a processor operably coupled to the transceiver, the processor configured to determine a first power for a reception of a first physical uplink control channel (PUCCH) based on:
the first PUCCH including first information bits that indicate a first operation state from the set of operation states for a first cell from the set of cells, and
a first value from the set of values for the power control parameter,
wherein the transceiver is further configured to receive the first PUCCH with the first power.

9. The BS of claim 8, wherein:
the transceiver is further configured to transmit:
third information for a second operation state from the set of operation states for a primary cell from the set of cells, and
fourth information for a reference signal (RS) resource on a secondary cell from the set of cells;
the second operation state is associated with an absence of transmissions of RSs on the primary cell,
the processor is further configured to determine a pathloss based on the RS resource;
the first power is based on the pathloss; and
reception of the first PUCCH is on the primary cell.

10. The BS of claim 8, wherein:
the transceiver is further configured to transmit third information for transmission of synchronization signals on a second cell,
the third information indicates:
a first periodicity associated with a second operation state, from the set of operation states, on the second cell, and
a second periodicity associated with a third operation state, from the set of operation states, on the second cell;
the processor is further configured to determine:
the second operation state or the third operation state on the second cell, and
a pathloss based on transmission of the synchronization signals according to the determined second or third operation state on the second cell;
the first power is based on the pathloss; and
reception of the first PUCCH is on the second cell.

11. The BS of claim 8, wherein:
the processor is further configured to determine:
a second operation state, from the set of operation states, for a primary cell during the reception of the first PUCCH,
the primary cell for the reception of the first PUCCH when the second operation state is not a predetermined operation state, and
a secondary cell for the reception of the first PUCCH when the second operation state is the predetermined operation state; and
reception of the first PUCCH is on one of the primary cell or the secondary cell based on the determination of the primary or secondary cell.

12. The BS of claim 8, wherein:
the processor is further configured to determine a second power for a reception of a second PUCCH based on:
the second PUCCH including second information bits that are not associated with an indication of an operation state, from the set of operation states, for a cell from the set of cells, and
a second value from the set of values for the power control parameter; and
the transceiver is further configured to receive the second PUCCH with the second power.

13. The BS of claim 8, wherein:
the reception of the first PUCCH in on a primary cell,
the determination of the first power is based on a first number of transmit power control (TPC) command values when an operation state for the primary cell is the first operation state from the set of operation states, and
the determination of the first power is not based on a TPC command value when an operation state for the primary cell is not the first operation state.

14. A method comprising:
receiving:
first information for a set of operation states for a set of cells, and
second information for a set of values for a power control parameter;
determining a first power for a transmission of a first physical uplink control channel (PUCCH) based on:
the first PUCCH including first information bits that indicate a first operation state from the set of operation states for a first cell from the set of cells, and
a first value from the set of values for the power control parameter; and
transmitting the first PUCCH with the first power.

15. The method of claim 14, further comprising:
receiving:
third information for a second operation state from the set of operation states for a primary cell from the set of cells, wherein the second operation state is associated with an absence of receptions of reference signals (RS) on the primary cell, and
fourth information for a RS resource on a secondary cell from the set of cells; and
determining a pathloss based on the RS resource,
wherein the first power is based on the pathloss, and
wherein transmission of the first PUCCH is on the primary cell.

16. The method of claim 14, further comprising:
receiving third information for reception of synchronization signals on a second cell, wherein the third information includes:
a first periodicity associated with a second operation state, from the set of operation states, on the second cell, and
a second periodicity associated with a third operation state, from the set of operation states, on the second cell; and
determining:
the second operation state or the third operation state on the second cell, and
a pathloss based on reception of the synchronization signals according to the determined second or third operation state on the second cell,
wherein the first power is based on the pathloss, and
wherein transmission of the first PUCCH is on the second cell.

17. The method of claim 14, further comprising:
determining:
a second operation state, from the set of operation states, for a primary cell during the transmission of the first PUCCH,
the primary cell for the transmission of the first PUCCH when the second operation state is not a predetermined operation state, and
a secondary cell for the transmission of the first PUCCH when the second operation state is the predetermined operation state,
wherein transmission of the first PUCCH is on one of the primary cell or the secondary cell based on the determination of the primary or secondary cell.

18. The method of claim 14, further comprising:
determining a second power for a transmission of a second PUCCH based on:
the second PUCCH including second information bits that are not associated with an indication of an operation state, from the set of operation states, for a cell from the set of cells, and
a second value from the set of values for the power control parameter; and
transmitting the second PUCCH with the second power.

19. The method of claim 18, wherein:
the determination of the first power is not based on a transmit power control (TPC) command value, and
the determination of the second power is based on a number of TPC command values.

20. The method of claim 14, wherein:
the transmission of the first PUCCH in on a primary cell,
the determination of the first power is based on a first number of transmit power control (TPC) command values when an operation state for the primary cell is the first operation state from the set of operation states, and
the determination of the first power is not based on a TPC command value when an operation state for the primary cell is not the first operation state.
